(19) United States
(12) Patent Application Publication
(10) Pub. No.: US 2011/0289158 A1
(43) Pub. Date: Nov. 24, 2011

(54) Physical Address Email System

(76) Inventor: Francesco Terranova, Redlands, CA (US)

(21) Appl. No.: 12/783,933

(22) Filed: May 20, 2010

(51) Int. Cl. G06F 15/16

(52) U.S. Cl. 709/206

(57) ABSTRACT

An electronic mail (e-mail) messaging system and method that allow e-mail to be sent and received between individuals identified by their physical mailing address. An e-mail address part of such system may include: (1) a first name (2) a street number (3) an initial representing geographical direction (4) a street name (5) a street type (6) an apartment number (optional), (7) a zip code. A registered such physical email address is linked with a regular email account and the system then forwards an email addressing the physical email address to the linked regular email account. If no linked regular email account, then the physical mailing address is constructed from the physical email address and the message is automatically delivered by physical mail means.

### DESCRIPTION OF RELATED ART

The present application relates to electronic mail (e-mail) system, and more particularly, to an email system using physical mailing address to construct email address; systems and methods for connecting users directly using physical mailing addresses as email address and targeting either specific users or all the users residing in any desired geographical area.

Note that the points discussed below may reflect the hindsight gained from the disclosed inventions, and are not necessarily admitted to be prior art.

Social networks such as Facebook, Myspace, Linkedin in recent years have allowed many companies and individuals (collectively, “users”) to become involved in an ever-growing electronic community.

In such community the key component of communication is the message often transmitted through the electronic mail (“e-mail”) from one user (a “sender”) to another (a “recipient”). One conventional e-mail protocol employed over the Internet, Simplified Mail Transfer Protocol (“SMTP”), mandates that each e-mail message body have a header that includes the sender's e-mail address (a “source address” or a “return address”) and the recipient's e-mail address (a “destination address”).

When a user establishes an account with an e-mail service provider, e.g., America Online™ or Hotmail™, the user usually constructs his/her own email username as email address, for example, jft1234@hotmail.com. This email name may contain no information about the user. Just looking at the email address one may not guess any personal information about the user. Another individual can send a message to the user by entering the user's e-mail address along with the message and sending it via the Internet.

E-mail can provide almost instant message delivery among individuals and businesses over vast distances for very little or no cost. E-mail also presents an opportunity for businesses to advertise to potential customers in a new way, e.g., by sending bulk advertisements via e-mail.

However, an individual cannot be reached unless he/she reveals his/her e-mail address to the sender. Such feature while providing a deep level of privacy constitutes a barrier to complete communication. In order to take advantage of the instant delivery and vast cost saving features of email system, commercial advertisers have been making enormous effort in collecting people's email addresses and in associating the email address with some meaningful user's personal information.

Postal services around the world have been delivering paper-based (“physical”) mail regularly for over a hundred years, causing mail to be recognized as a reasonably reliable medium for business and personal communication.

From a marketing point of view traditional mail service is the only feasible way to reach any home in a desired geographical area. This is true unless a recipient voluntarily subscribe to a merchant's newsletter.

US 2002/0059381 A1 has proposed an email system by associating email addresses with physical addresses to inhibit the receipt of unwanted e-mail, so the communicators can rely on the physical address to correctly identify the sender and/or recipient.

By establishing an electronic account for a customer on a network, where the customer's electronic address is linked to the customer's physical address, a customer is able to send and receive e-mail, as well as conduct electronic transactions securely by linking a customer's electronic address to the customer's physical address.

The system determines a standardized physical address of a user with an electronic account by sending a query from an address matching engine to an address matching directory database. The address matching directory database retrieves the standardized physical address of the user based on the query and sends the standardized physical address to the address matching engine. The standardized physical address is linked to the electronic account.

This system also delivers a physical message in an electronic format to users with an electronic account and a physical address. When the physical message directed to the physical address for each of the users is received, an electronic address for each of the users is determined from the physical address of each user, and the physical message is sent in an electronic format to the electronic address for each of the users.

However, in order to use this feature, a special user interface for senders needs to be specifically implemented to take input of the physical address of a recipient. A sender still cannot reach a recipient if he has no email account associated with the physical address.

### SUMMARY

The present application discloses new approaches to an email system that directly uses physical address as email address. Current email protocols need not be modified and no special new user interface is needed for input of the physical address of a recipient.

A database of email addresses can be built simply based on a directory of physical mailing addresses, for example, a phone book; this database needs not be changed as long as the physical addresses are not changed. For example, the email addresses may be built as a unique sequences of (1) a first name, (2) a street number, (3) an initial representing geographical direction, (4) a street name, (5) a street type, (6) an apartment number, (7) and zip code, with special characters, such as, an underscore, or a question mark, separating each field.

In another embodiment a system for constructing a user's e-mail address includes attaching to the user selected username with either a city name, or a zip code, or the coupling of a city name and one or more streets, or a specific email address so to isolate one or a list of physical addresses.

The disclosed innovations, in various embodiments, provide one or more of at least the following advantages. However, not all of these advantages result from every one aspect of the innovations disclosed, and this list of advantages does not limit the various claimed inventions.

The disclosed novel email system makes use of the current available email system, does not require new implementation of user interface, all changes may happen at the server level.

By incorporating physical address directly into user's email address, the system allows targeted emails be delivered to specific geographic area without further efforts of collecting recipients' personal information; it also allows senders and recipients the ability to decide whether an email is a spam or wanted email by using the geographic information of the sender's email address.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 schematically shows example interactions between the conventional email system and the physical address email system in accordance with this application.

FIG. 2 shows an example use of the physical address email system in accordance with this application.

FIG. 3 shows an example mechanism of utilizing the email address provided by the physical address email system in accordance with this application.

FIG. 4 shows another embodiment of the physical address email system in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

Email system is the most efficient and convenient way of modern communication and socialization, however, it lacks the geographic specific features currently enjoyed by the physical mail system. Combining the physical address ability with the email system enables the email system to also enjoy these features of physical mail system.

To overcome the shortcoming of needing to implement new user interface for sending physical address linked emails in prior art, and to fully take advantage of the current available system, a novel physical address email system is designed.

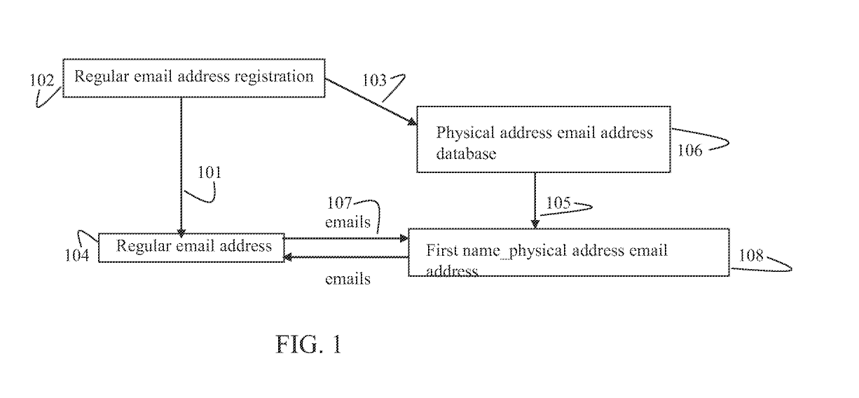

In reference to FIG. 1, a physical address email address database 106 is constructed by using known physical addresses, such as, the listings of a phone book. For example, the email address is a unique sequence comprising 7 fields of (1) a first name (2) a street number (3) an initial representing geographical direction (4) a street name (5) a street type (6) an apartment number (optional), (7) and zip code, separated with a unique symbol, such as a “$” or a “&”. When a user is at regular email registration module 102 to register for regular email address 104 at step 101, his/her physical address may be requested at step 103, a matching physical email address 108 can be assigned at step 105.

A sender without knowing the registered regular email address 104, can still send email to the recipient's physical email address 108 by constructing the physical email address using the recipient's physical mailing address according the prescribed rule. The server then automatically forwards the email to the regular email address 104 at step 107.

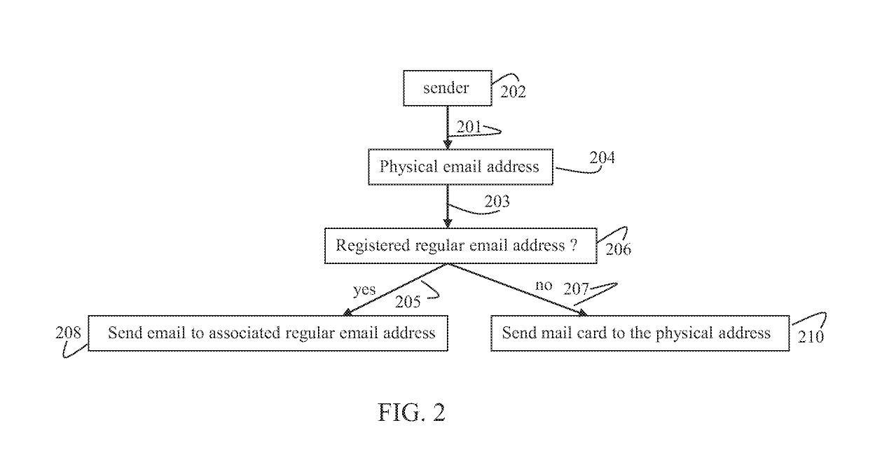

In reference to FIG. 2, sender 202 sends an email to a physical email address 204 constructed from the recipient's physical address according to the email address rule, the mail server module 206 automatically checks if there is any regular email address is linked with this physical address with a matching name at step 203. If the answer is yes, at step 205, the mail server module 208 forwards the email to the linked regular email address. If the answer is no, at step 207, the mail server module 210 prints an invitation to register for the service either on a postcard or a letter and the card or the letter is then delivered by the post office to the physical address.

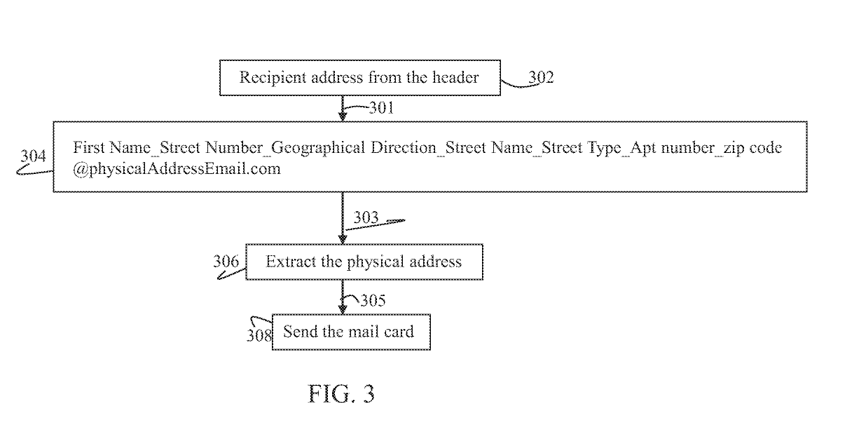

In reference to FIG. 3, the recipient's physical address 306 can be simply extracted the message header 302 and the email address 304 at step 303. The physical address can then be used for mailing the printed message at step 305.

In this system, the sender directly uses the current emailing protocol to send an email to a physical email address, no new user interface is needed to take the input of a physical address as well as a regular email address. The sender's message will reach the recipient even if the recipient does not have an email address.

For advertisers or social activity organizers targeting a specific geographic area, group emails may be sent to email address containing, for example, certain zip code.

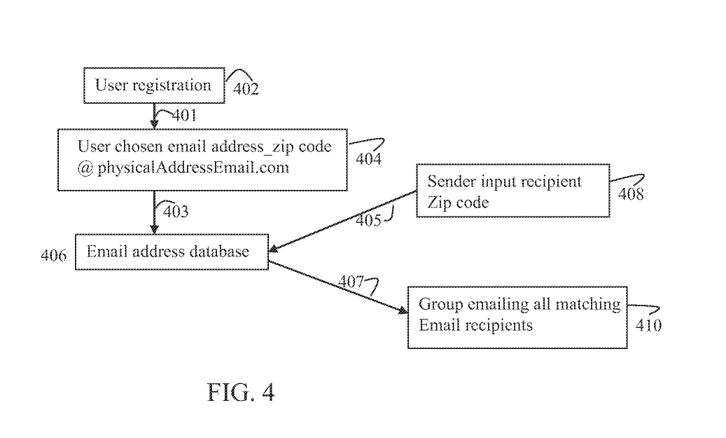

In another embodiment, as shown in FIG. 4, a regular email address may be appended with a geographic content, for example, a zip code or a city name. At email registration module 402, a user selected email address is further appended with a geographic content at module 404, and this final address is then produced to the user and saved to the email address database 406. For commercial senders or social activity organizers targeting a geographic, group email may be sent to email addresses containing certain zip code or city names. Module 408 takes the input of geographic information, and email addresses containing the zip code or city name can be retrieved at step 405 from the email address database 406, and group emails can be sent automatically by module 410. No specific physical address database is needed to be built and be linked with a regular email address database.

The e-mail address of each individual part of the system will hold enough data to uniquely identify physical mailing address of their intended recipients.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Additional general background, which helps to show variations and implementations, may be found in US Patent Application US 2002/0059381 A1, the entirety of which is hereby incorporated by reference herein for all purposes.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A physical address email system, comprising:
email account registration module that takes input of a applicant's geographic physical address information, and assigns the applicant an email account and a physical-email address based on the geographic physical address information; and
an operation module that checks whether an incoming email address is a registered physical-email address, and if the incoming email address is a registered physical-email address with a registered email account, it forwards the incoming email to the registered email account; if the incoming email address is a physical-email address but not a registered physical-email address, it delivers the email message via a physical mail system.

2. The email system of claim 1, wherein the registration module assigns a physical-email address by constructing the geographic physical address information into a unique sequence as the physical-email address in accordance with a constructing rule.

3. The email system of claim 1, wherein the registration module assigns a physical-email address by constructing a unique sequence comprising fields of (1) a first name, (2) a street number, (3) an initial representing geographical direction, (4) a street name, (5) a street type, (6) an apartment number, (7) and zip code, each field being separated with a special character from each other.

4. The email system of claim 1, wherein the registration module assigns a physical-email address by attaching a selected geographic information of the applicant to a unique username chosen by the applicant.

5. The email system of claim 1, wherein the registration module assigns the applicant both a regular email address and a physical-email address.

6. The email system of claim 1, wherein the registration module assigns a physical-email address by selecting a matching physical-email address from a pre-built physical-email address database.

7. The email system of claim 6, wherein the pre-built physical-email address database is built by using a real physical address directory including a phone book.

8. The email system of claim 1, wherein the operation module reconstructs an email recipient's physical address by extracting geographic information from the incoming email's email address.

9. The email system of claim 1, further comprising a user module that automatically constructs physical-email addresses from an input of a geographic feature and by using a physical address database.

10. An email address user interface, comprising a module that automatically constructs physical-email addresses from an input of a geographic criterion and by using a physical address database.

11. A method of distributing plurality of emails to recipients of a geographical area, comprising the actions of:
constructing plurality of physical-email addresses using a user interface of claim 10 by inputting a geographic criterion; and
sending a message to the plurality of physical-email addresses using the email system of claim 1.
